(19) United States
(12) Patent Application Publication
(10) Pub. No.: US 2017/0243254 A1
(43) Pub. Date: Aug. 24, 2017

(54) SYSTEM AND METHOD FOR DYNAMICALLY ESTABLISHING CONTENT ADVERTISEMENTS

(71) Applicant: Francisco Javier LOPEZ CANIEGO, Madrid (ES)

(72) Inventor: Francisco Javier LOPEZ CANIEGO, Madrid (ES)

(21) Appl. No.: 15/242,536

(22) Filed: Aug. 21, 2016

(30) Foreign Application Priority Data
Feb. 18, 2016 (ES) 201630183

(51) Int. Cl. G06Q 30/02

(52) U.S. Cl. CPC G06Q 30/0269

(57) ABSTRACT

A method and system for dynamically establishing content advertisements where the method comprises the steps of (a) receiving a content request from a user device where said request includes information for identifying said user, (b) obtaining the profile of the user from said identification information of the user, (c) obtaining an advertising plan for said content requested for said user based on the profile of said user and the advertising spaces available in said content where said obtainment of the plan comprises the steps of (i) selecting a first set of advertisements, the target audience of which has the same characteristics as those of the profile of said user, (ii) selecting a subset of said first set of advertisements which fulfill the following: they have not fulfilled the coverage objective or is not within the coverage range which they had fixed and they have not fulfilled the objective number of impacts or is not within the range of advertising impacts for said user, or they have fulfilled the coverage objective or is within the coverage range which they had fixed, they previously impacted on this user and have not fulfilled the objective number of impacts or is not within the range of advertising impacts for said user and (iii) selecting a subset of the subset obtained in the previous step (ii) which fits into the advertising spaces available for said content; (d) including said advertisements obtained in (c) in said advertising spaces of said content and (e) showing said content with said advertisements on the user device (110).

### RELATED APPLICATION

This application claims the benefit of priority of Spanish Patent Application No. 201630183 filed Feb. 18, 2016, the contents of which are incorporated herein by reference in their entirety.

### FIELD AND BACKGROUND OF THE INVENTION

The present invention is centered on the advertising sector and relates to the planning, emission and pricing system for advertisements segmented in a content platform. In particular, the invention relates to a system for managing advertising and to a method for dynamic pricing according to the target, coverage and number of impacts per person.

Advertising forms part of the majority of communication means, including free TV, subscription video on demand (SVOD) platforms, paid TV, radio, written press or internet.

The revenues obtained from the advertising serve in many cases to finance the communication means, completely in some cases; as is the case of free television, radio free video platforms such as for example YouTube or Vevo, or many websites, especially social networks such as Facebook, Twitter, etc. In other cases, these revenues for advertising finance it partially, such as paid content platforms such as SVOD platforms, satellite, cable, pay-per-view, subscription news content such as online newspapers or magazines. Without advertising, these means would be very expensive.

The main objective of the advertisers in communications campaigns is to make known, create or improve the brand image and create predisposition to purchase the products, services, brand, etc., reaching segments of the audience. The ultimate aim is to generate or increase sales, the prestige of the brand and associate the brand with certain values and advantages in the mind of the consumers.

Normally, the advertisers wish to communicate with certain segments of the population having socio-demographic characteristics and specific lifestyles. Whether it is age, sex, income level, social class, geographic location, interests (such as for examples they like travelling, playing golf, tennis, cars, etc.). This information can be collected in content provider internal databases, advertising management platforms or external databases such as DMPs, social networks, etc. The individuals within a specific set of characteristics are called objective or target audience. At the same time, the advertisers wish to carry it out such that their message reaches the greatest number of individuals within their target audience, called net coverage or reach in the advertising target.

For example, this net coverage or reach can be expressed both as a percentage (%) of individuals impacted at least once from among the total number of individuals of the target in the population universe. It can also be simply expressed as a figure for individuals of the target in the population universe. For reasons of brevity and simplicity, from now on in the specification, net coverage or reach will simply be referred to as coverage.

In the same way, said advertisers wish for this message to impact a determined number of times on each individual. This is called impact, contact, impression, etc. depending on the specific advertising medium and format. As it will be an opportunity for them to see you, it is called opportunity to see (OTS). For reasons of brevity and simplicity, from now on in the specification, impacts, contacts, impressions, etc. will simply be referred to as impacts or OTS.

The advertisers judge the minimum number of times that the message should impact on each individual in order to create a reaction to the individual, whether it is brand recall, purchasing propensity, etc. For example, in the high consumption products, it is judged that this number should be 4 as a minimum. In this way, the message permeates or reaches, otherwise, the message is not recalled and the impact will have been lost. For example, in a high consumption product, it is estimated that an individual has to be impacted 4 to 6 times in order to generate a recall and/or a reaction with less impact the communication has no effect and with more there is no greater learning or greater recall.

Nowadays, these communication objectives are sought by making a media plan in different communication mediums. There are mediums which cannot establish these objectives or effectively target the advertising, but which have large coverage, such as free television. Other mediums may be more precise in segmenting and targeting the advertising depending on the individual who is viewing it. However, in none of the cases is the medium committed to providing coverage and a number of impacts per individual of the target audience, determining these parameters as an objective of the advertising campaign. Therefore, the planning and assignment of campaigns in the advertising spaces, the prices negotiated for the same are not fixed as a function of the coverage and number of impacts per individual of the target audience that said campaign has as the objective to be reached.

In terms of the form of segmenting the target audiences, there are an infinite number of methods and variables. For example, by socio-demographic values as television does with its audiences, by sex, age, income level or social class, whether or not they have children, if they are a housewife or breadwinner, etc. and/or by lifestyle, that is to say, if they like travelling, technology, cars, golf, etc.

In the current systems for managing advertising, the planning and pricing is fixed in different manners according to the communication mediums.

For example in free television, the price is usually fixed according to some of these criteria:
According to a tariff which depends on the total audience of the content and/or the majority profile of the audience of the content which has been estimated for this content. A discount on the same can be negotiated.
Cost per thousand impressions (CPM) or in other words, per thousand viewers of a determined objective or target audience who views the campaign of the advertiser.
Cost per gross rating point (GPR). In other words, cost for each GRP of a determined objective or target audience who views the campaign of the advertiser.
   However, as we have previously mentioned, in none of these methods are the planning and assignment of campaigns in advertising spaces, nor the prices negotiated for the same fixed as a function of the coverage and number of impacts per individual of the target audience that said campaign has as the objective to be reached.

In other mediums, like the internet, the price is usually fixed by these other criteria:
Cost per thousand impressions (CPM) similar to TV on users fixed in advance which can be users who access a certain webpage, certain content, or even depending on the target of the user. However, again, without taking into account the coverage and the number of impacts per user of the campaign.
Cost per click (CPC), that is to say, the amount for each one of the clicks that are generated via a creative advertisement.
Cost per acquisition or purchase (CPA). An amount for each one of the clicks that is generated on a creative advertisement and that has led to a purchase.
Cost per lead (CPL). An amount for each click that leads to an action, agreed in advance in the campaign, specific to a user such as filling in a form, subscribing, etc.

Similarly, in none of these methods are the price or the assignment of the advertising campaigns (advertisements) to be viewed determined by the coverage and the number of impacts per user of the target audience to be reached.

There are solutions like the one set out in US-20080052171-A1 where a system for selecting advertisements is shown based on establishing a vector with information on the real or hypothetical market for a product and also has a user identification which is used for recovering a determined profile or vector of consumer characteristics such that both pieces of information are correlated, the vector of the advertisements and that of the user in order to establish the ideal advertising for this type of user.

Other solutions such as the application US-20150201229-A1 describe a method and a system for managing advertising to subscribers in pre-recorded programs such that said advertising is established as a function of the type of program and the profile of the potential subscribers who can view it.

There is also the U.S. Pat. No. 7,949,565-B1 which is centered on creating a database of anonymized user profiles with demographic, consumer attributes, etc. such that the advertising managers can access said information and consult based on the objective profiles that they have for their advertisements and therefore obtain information that is not private, on the rest of the profile which fits their request.

The U.S. Pat. No. 8,352,320-B2 relates to a system for managing advertising and a method with dynamic pricing where a series of advertisement levels is defined and each one with a set of advertisements where the levels are grouped by price and when advertisements are included by the advertisers, they are assigned first to the lowest levels, low price and then they progress to the higher levels as a function of the demand

### SUMMARY OF THE INVENTION

An alternative to the state of the art covering the gaps found in the same must be provided.

Specifically, a method and a system for dynamically establishing content advertisements is proposed where the method comprises the steps of (a) receiving a content request from a user device where said request includes information for identifying said user, (b) obtaining the profile of the user from said identification information of the user, (c) obtaining an advertising plan for said content requested for said user based on the profile of said user and the advertising spaces available in said content where said obtainment of the plan comprises the steps of (i) selecting a first set of advertisements, the target audience of which has the same characteristics as those of the profile of said user, (ii) selecting a subset of said first set of advertisements which fulfill the following: they have not fulfilled the coverage objective or is not within the coverage range which they had fixed and they have not fulfilled the objective number of impacts or is not within the range of advertising impacts for said user, or they have fulfilled the coverage objective or is within the coverage range which they had fixed, they previously impacted on this user and have not fulfilled the objective number of impacts or is not within the range of advertising impacts for said user and (iii) selecting a subset of the subset obtained in the previous step (ii) which fits into the advertising spaces available for said content; (d) including said advertisements obtained in (c) in said advertising spaces of said content and (e) showing said content with said advertisements on the user device.

In turn, the system for dynamically establishing content advertisements comprises (a) a user device disposed for sending a content request and receiving and showing said content with advertisements, where said request includes information for identifying the user of said device, (b) a content platform disposed for receiving said content request and requesting an advertising plan indicating information of said user and the advertising spaces available for said content to an advertising management platform, receiving said plan from said platform, including the advertisements of said plan in said content and sending said content with the advertisements to said user device, (c) an advertising management platform disposed for receiving an advertising plan request for the advertising spaces available for said content and for the profile of said user where the obtainment of said plan comprises the steps of (i) selecting a first set of advertisements, the target audience of which has the same characteristics as those of the profile of said user, (ii) selecting a subset of said first set of advertisements which fulfill the following: they have not fulfilled the coverage objective or is not within the coverage range which they had fixed and they have not fulfilled the objective number of impacts or is not within the range of advertising impacts for said user, or they have fulfilled the coverage objective or is within the coverage range which they had fixed, they previously impacted on this user and have not fulfilled the objective number of impacts or is not within the range of advertising impacts for said user and (iii) selecting a subset of the subset obtained in the previous step which fits into the advertising spaces available for said content; and where once said subset is selected, it is returned to the content platform.

The state of the art does not show any system for managing advertising which allows a client (advertiser, media agency, a buyer of advertising spaces in general, etc.) to ensure that all their impacts are going to be directed at achieving their communication objectives in terms of coverage and number of impacts (OTS) per individual for a referenced selected segmented target audience.

Therefore, advantages with respect to the known state of the art can be understood as the optimization of the number of impacts required (OTS) for reaching the communication objectives of an advertiser in terms of coverage and OTS in the target audience sought, ensuring that all the impacts are going to be effective and optimizing the price of the campaign. At the same time, the saturation effect is avoided which is caused when a user has seen a determined advertisement too many times and which ends up causing rejection of the product or service advertised.

Moreover, since it is advertising segmented to the profile of the subscribers or users, it will be more relevant for those individuals and less irritating, consequently it will increase the efficacy of said advertising.

In addition, another advantage would be that since the number of impacts (OTS) per user is limited and impacts on individuals who do not have the profile of the campaign is not wasted, there will be less advertising shown to each user, increasing their satisfaction and reducing the “advertising noise”, consequently the efficacy of the advertisement will increase.

### BRIEF DESCRIPTION OF THE SEVERAL VIEWS OF THE DRAWINGS

With the aim of aiding the understanding of the characteristics of the invention, according to a preferred practical embodiment of the same and with the aim of complementing this description, the following figures are attached as an integral part of the same, which have an illustrative and non-limiting character:

FIG. 1 shows a general diagram of the system object of the invention for the case in which the user is registered or subscribed to a content service and the content platform has a database with the profiles of said users.

FIG. 2 shows a general diagram of the system object of the invention for the case in which the user is not registered directly to the service and the characterization of the users and their identification is obtained indirectly by way of the information which arrives in the content request and with information which the advertising management platform has on user profiles and an external database with user profiling.

FIG. 3 shows a general diagram of the system object of the invention for the case in which the advertising management platform, the functionality thereof, forms part of the content management platform.

### DESCRIPTION OF SPECIFIC EMBODIMENTS OF THE INVENTION

The object of this invention comprises a system and a method for dynamically establishing advertisements as a function of segmentation criteria of the users of a content platform while said users are viewing the different contents of the platform. Said segmentation criteria can be socio-demographic (age, sex, economic level, geographic localization, etc.), lifestyle, etc.

The characteristics of the user should coincide with the profile sought by the advertising campaign. Moreover, the advertising campaign has objectives in terms of coverage or coverage range in the profile sought and the number of impacts (OTS) or impact range to be reached in each individual or user.

The provider of the advertising opportunity (content platforms such as TV or video, webpage, social network, etc.) provide a series of available advertising space(s). The advertisements included are determined depending on the fitting of the different objectives of the campaign, that is to say, that the profile of the subscriber or user coincides with the profile of the advertising campaign and that it is within the coverage or coverage range and number of impacts (OTS) or objective impact range, in addition to the planning requirements on the part of the advertiser (campaign dates, restrictions, etc.), the prices in the contract and the prices of the advertising space(s) (time or number of advertisements) available.

In the present invention, the content platform (200) could be a streaming video on demand platform, an IPTV platform, cable television platform, an internet video platform such as YouTube, Vevo or written and image media of the more traditional web server type, a social network, etc.

Such content platforms have a content server (210) which shows said content to the users who request it.

In the invention it is very important to be able to perfectly individualize the users and therefore to be able to know all or part of the characteristics of said user who uses the content platform. In any case, always respecting privacy laws without making known identifying details or private personal data of the user. At the same time, said platform is capable of generating and sending an advertising plan with the corresponding advertisements thereof in real time.

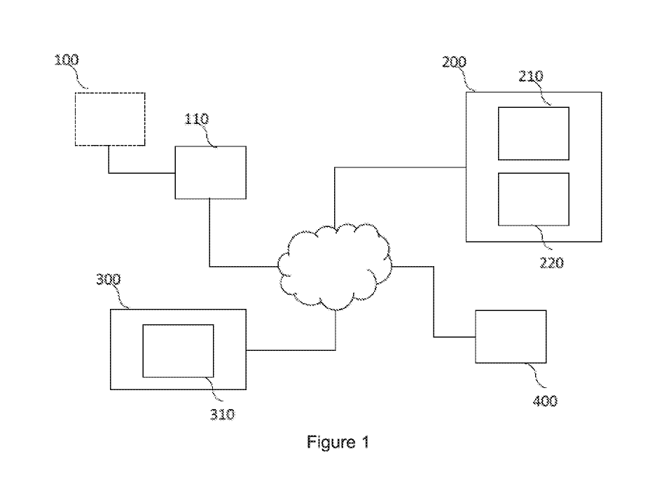

In one embodiment of the invention, as is observed in FIG. 1, a user (100) subscribed to a content platform (200) accesses said platform by means of using a user identification and a password. A typical example of this type of access is where said content platform is an SVOD.

In this embodiment, the content platform (200) has an internal database (220) with the characteristics or profile of each user, such as age, sex, economic or purchasing profile, geographic location, content types which they usually access, interests, etc. and therefore by way of query to said database (220) with the identification of the user, the entire profile or characteristics of said user can be obtained.

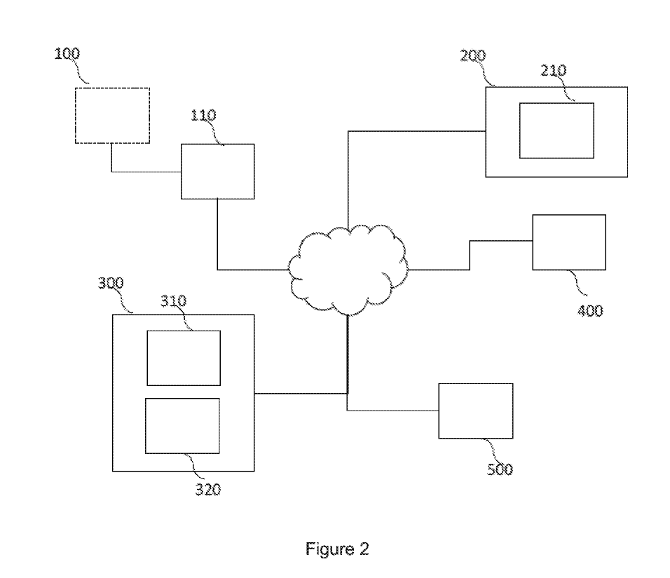

In another embodiment, as is shown in FIG. 2, there is also the possibility of said user (100) accessing said content platform (200) without authenticating himself during each access, but rather the access is authorized by way of the use of cookies or another type of information available and/or related to the device of the user such as an IP address from which the user accesses the content. Generally, with these types of access, said content platform corresponds to web servers.

In this embodiment, the available information of the user, such as type of device, IP address, cookies, etc. generally does not as such allow the user to be identified unequivocally and therefore, what is proposed is that said information goes directly to the advertising management platform (300).

From here, the information which identifies and characterizes the user can be obtained by way of internal and/or external databases such as a data management platform (DMP) (500) which is very useful in the environment for managing advertising or other similar solutions and which mainly manage information centrally for the advertisers such as for example, surfing carried out on the internet by the advertisers, including clicks, times, etc., online marketing campaign information, types of devices from which they access and also, in some cases, being supported by other data sources or data itself, information on the users who access these content sources, as well as the characterization thereof (age, gender, interests, etc.).

For example, in one preferred embodiment, the advertising management system (300) has an internal database with characteristics of the users (320) and in order to identify the user unequivocally this internal information is combined with a query to an external data management platform (500) such as is observed in FIG. 2.

With the direct identification of the user—user identifier and password, or indirect identification, cookies, IP, query to DMP, etc., a unique user identifier and characteristics or profile associated with said user is available.

The user, in all cases, accesses from a user device (110) such as a television, a computer (laptop or desktop), a tablet, a smartphone, etc.

When the user (100) requests to see or access content, whether it is new or additional parts of content which they were already viewing, for example a streaming video, the request reaches said content platform (200) and said platform (200), according to the advertising scheme which it follows, that is to say, a number or time of advertisements for each x minutes of content or for each new webpage provided, etc., communicates or notifies this to an advertising management platform (300) (AMS) which is responsible for creating a segmented advertising plan to be shown to said user.

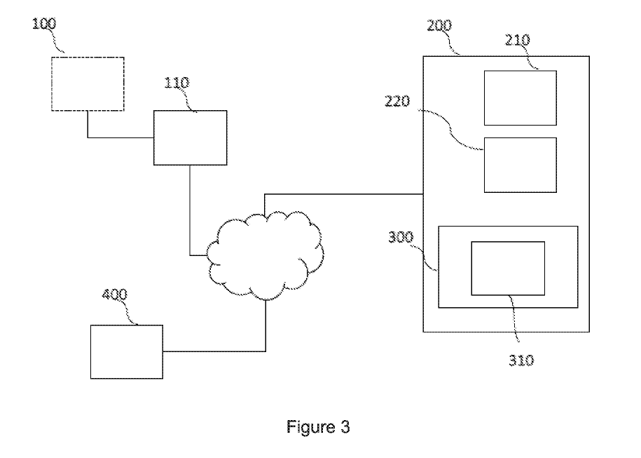

From the point of view of implementing the invention, it can be understood without limiting and detracting from the scope of the invention that the content management platform (200) and the advertising management platform (300) can be separated and managed independently as is described below or shown in FIG. 1 or 2 for the purposes of separating the functionalities which each one carries out, but it can also be understood that said platforms, with the complete functionalities thereof, can be integrated in a single solution or in the same entity as is shown in FIG. 3.

In one embodiment, said content platform (200) sends, in said notification to said advertising management platform (300), the unique identifier of the user which carries out the request together with the profile or characteristics thereof and which said content platform has stored in said internal database (220).

Whereas if said content platform (200) does not have said internal database (200) and the user is not identified with a unique identifier, the content platform (200) sends, in said notification to the advertising management platform (300), the indirect information associated with said user and received in the request of the content, such as for example the IP address, type of user device, cookie, etc., and the advertising management platform (300) is responsible for obtaining the profile or characteristics of the user with a combined query between the internal databases thereof (320) and an external database such as a DMP (500), as has been previously described.

In another embodiment of said content platform (200), it also includes in said notification, information on one or various advertising spaces—time, location, number, etc. available to be incorporated in the content to be shown to the user.

Said advertising management platform (300) has a database (310) for advertising campaigns which are segmented or characterized by different criteria related to potential or real market aspects, that is to say, target audience, but the characteristics of which are relatable to the types of characteristics of a user (age, sex, economic or purchasing profile, geographic location, type of content which is usually accessed, interests, etc.).

Additionally, the advertising campaigns stored in said database (310) include information on the objectives to be achieved with said campaigns, generally referring to the specific number of impacts (OTS) or to an impact range, that is to say, between a minimum and a maximum to be had per individual and also the coverage objective or in other words, the number of different individuals who they desire to view this campaign (expressed as a % of the population universe of the target or directly as a number of individuals of the target in the population universe). Similarly, information is stored on the degree of compliance of said objectives at a given moment. Similarly, the coverage objective can also be reflected as a coverage range, with a minimum and a maximum.

Among the objectives to be achieved with an advertising campaign and mainly linked to the population coverage which is desired to be reached, the population universe on which said coverage objective is applied can be limited to a determined geographic scope. That is to say that the coverage can be expressed in this case as both the percentage of the population universe of a geographic area or directly as a number of individuals within the population universe of a geographic area.

Similarly to such advertising campaigns, information relating to the activity they involve is also stored, such as cost of the campaign, the price for each impact (OTS) or per thousand impacts (CPM), etc.

In this way, said advertising management platform (300), in order carrying out the selection of advertisements to be planned for said user, carries out the steps indicated below:
From among the advertising campaigns available in said database (310), advertising campaigns are selected which have a target audience with characteristics matching the characteristics of the user for whom the selection is intended.
From this subset of advertising campaigns, advertising campaigns are selected which have not yet fulfilled their objectives of global coverage or coverage range and the objective number of impacts (OTS) or the objective impact range desired for each user or which have fulfilled the coverage objective or is within the coverage range which they have fixed which have previously impacted this user and which have not fulfilled the objective number of impacts or is not within the range of advertisement impacts for said user.
From the resulting campaign subset, that is to say, the campaigns directed at this type of user profile and which have not yet fulfilled their coverage objectives or coverage range and number of impacts (OTS) or impact range for said user or which have fulfilled the coverage objective or is within the coverage range which they have fixed, which have previously impacted on this user and which have not fulfilled the objective of number of impacts or is not within the range of advertising impacts for said user, a number of advertisements are selected such that it fits—number, time or duration, etc, the information received in the notification of the content platform (200) regarding the advertising spaces available for said content to be shown to the user.
Additionally, for said selection, different criteria can be used such as choosing the advertising campaigns which are directed at a more segmented audience, that is to say, there are fewer individuals that fulfill the characteristics of the profile or the campaigns where it is more complicated to obtain the objectives because the profile sought is difficult to impact and/or the coverage objectives or coverage and impact range (OTS) or impact range are higher, etc.
Preferably, in one embodiment, said selection criteria consists of choosing campaign(s), the price per impact of which is greater.

Once the advertisement(s), which are desired to be included in the content requested by the user, are selected, said advertisement(s) are requested from an advertisement server (400) and are inserted in said content according to the advertising spaces available and said content is shown to the user.

Additionally, the databases of the campaigns (310) are updated, indicating that said user has seen said campaigns or advertisements and the number of impacts for these campaigns is also updated such that the coverage and number of impacts is known at any time both at a global level and for each user or individual.

Going into further detail on the definition of an advertisement campaign, in one embodiment, said campaign may include at least the variables described below:
The target audience for which it is intended, being defined for example as housewives, young people between 16 and 34 years of age from Madrid, middle-class individuals between 25 and 45 years of age, etc.).
   The objective coverage which is desired to be had with said campaign, that is to say, how many people or individuals are desired to be reached. This information can be expressed in an absolute value, in a range of absolute values or as a percentage or range of percentages of a number of individuals of the target audience, which is also referred to as the target or objective universe that is desired to be reached.
The number of objective impacts (OTS) or objective impact range for each different individual or user.
The cost per volume of impacts, that is to say, when it costs the advertiser each time that a determined number of impacts is produced. In the world of advertising, the cost per thousand impacts or CPM is usually used as a variable.

Using the advertising management scheme of this invention, dynamic campaign price polices can be defined, that is to say, the total price of the campaign—number of impacts reached per cost of said impacts—may be different depending on the profile sought, the coverage or objective coverage range and the objective number of impacts (OTS) or objective impact range per user, unlike the known state of the art.

Therefore, in order to fix the definitive price of a campaign, the combination of the following factors has to be taken into account:
Objective profile or target. The price will be different depending on the objective profile desired. It is well known in the market that there are audiences more likely to purchase, more receptive to advertising messages, to change products, etc. Therefore, the price for reaching these groups will be greater. Similarly, there are determined audience segments for which there is a greater offer of products or services on the part of the advertisers, consequently there is greater competition for the advertising spaces directed at these audiences, once again, the price should be greater for these groups.
Coverage or coverage range. Similarly, it is well known in the advertising market that the more coverage is desired to be reached among the target audience, the more advertising force must be made. Since the target audience will be fragmented between the different mediums and the more coverage is desired to be reached, the more difficult it is to find these different individuals in the different advertising mediums, and more probabilities of wasting impacts directed either at an audience which is not the objective or target, or repeating too many impacts on individuals of the target audience who desire to be reached. All of this entails the cost per effective impact increasing, the more coverage is desired to be reached. The increase may even be exponential depending on the levels of coverage desired.
Number of impacts (OTS) or impact range on each individual. Similar to the coverage, as the objective number of impacts on each individual increases, the price per impact increases. This is due to the fact that the media consumption is variable depending on the individuals and there will be individuals with a low media consumption. This means that it will be more difficult to impact on this individual with the desired number of impacts, the greater the desired number of impacts is. Moreover, the media consumption varies according to the population segments, since there are segments which tend to consume more communication mediums and therefore they will be easier to impact a determined number of times.

Therefore, the price will be defined by a composition of these three factors. Additionally, they may be tolerance margins in terms of coverage or coverage range and number of impacts (OTS) or impact range for modifying the price, according to a correction %, for the cases where it has not been possible to reach the objective coverage or the coverage minimum for the case of ranges and/or the number or impacts or the minimum number of impacts for the case of ranges due to different factors such as insufficient inventory, many campaigns competing for the same advertising opportunities, technical errors, etc.

In one embodiment of the invention, the selling of advertising supported by this advertising management system is carried out by way of an easy-to-use online platform such that the different clients, that is to say, advertisers, media agencies, etc., can access the platform and fill in a form where they state the advertising campaign that they want to purchase. In said form, they will have to fill in the characteristics of the same, among which will be target audience, coverage or coverage range and number of impacts or impact range per desired individuals, dates of the campaign, geographic scope (for example, national, Madrid, Catalonia, etc.), etc.

The platform in this case offers a bid price for this campaign, as a price suggestion for the same. The advertiser fills in the total price of the campaign that he considers most appropriate, without being obliged to insert the bid price offered. At the same time, the media are offered to the advertiser so that he can introduce and manage, from the platform, the advertising creativeness which he desires to be included in his campaign and the order of presentation of the same to each individual in each one of the views of his campaign.

The allocation will be by means of an auction where, depending on the inventory, the campaign demand and the price of the same for the different targets, with the corresponding coverages and OTS thereof, it will be decided which campaigns should be allocated.

As an example of the previously described embodiments, it can be deduced, for example that the price per impact to reach an individual between 25 and 45 years of age is different to that for reaching a man of 35-50 years of age, for example. At the same time, it is also different for different coverages and/or OTS, although they are directed at the same profile.

Another example: two campaigns directed at men of 35-50 years of age, one wants 50% of coverage and 4 OTS, that is to say, it wishes to impact 4 times on each one of the men of 35-50 years of age on which the campaign impacts, wishing that it is 50% of the men who are in the geographic scope of the campaign. It may be Madrid, Spain, USA, etc. the population universe of men of 35 to 50 years of age being different in each case and the other campaign, 60% of coverage and 4 OTS, the price per impact of the second is greater than the first since, as is known in the industry, the higher the number of different individuals that is desired to be impacted, the more difficult it is to do so and therefore, the price reflects this difficulty. The same occurs with the OTS.

Evidently, in the second case the total price of the campaign will be greater since the greater price per impact will have to be multiplied by the greater number of impacts which will have to be carried out for impacting this greater number of different individuals.

A first exemplary use of the invention that is adapted to the system scheme reflected in FIG. 1, would be that of a content platform which the invention would use to sell its advertising inventory. In this case, the user of said content platform (SVOD) is identified in order to access the platform and view content. At the time at which the subscriber makes a request to see content, whether it is new or additional parts of the content they were viewing, for example a streaming video according to the advertising scheme which the content platform follows, such as a number or time of advertisements for each x minutes of content or for each new webpage provided, etc., the information corresponding to the subscriber is sent to the advertising management platform (300) (AMS) in order to show the subscriber an advertisement. The content platform sends all the information with the user identifier and with the socio-demographic characteristics and other available characteristics of said user.

For example a user could have an ID: 485, with characteristics such as 34 year old, middle-class woman in Madrid who is a housewife. Once the advertising campaigns which fit the profile of the user have been identified and which still have not achieved their coverage objectives or coverage range and/or number of impact or impact range per individual for this user, the criteria is applied for selecting the campaign which, for example has a higher price.

The AMS consults the creativity corresponding to this campaign in the ad server and returns it to the content platform in order for the user to view it, noting the viewing of said campaign for this user in the database of the AMS.

A second exemplary use, more adapted to the system scheme shown in FIG. 2 consists of the user not having an account or is not “logged” into the system, but has authorized the use of cookies to access a content webpage. This content webpage sends the request to the AMS, in this case, only with the information of the cookie, IP and access device.

By means of the query to its internal databases and exterior databases supplied by a DMP (data management platform), the AMS cross-checks and compares the information and establishes that it is the user, for example, who has an ID: 689 which corresponds to a 48 year old, upper-middle class man from Barcelona, whose hobbies are travelling, playing golf and tennis.

Again, once the advertising campaigns which fit the profile of the user have been identified and which still have not achieved their coverage objectives or coverage range and/or number of impacts or impact range per individual for this user, the final selection criteria of the campaign to be shown could, for example be applied such as that for which it is more complicated to fulfill the objectives of target, coverage and number of impact.

Lastly, the AMS would consult the creativity corresponding to this campaign in the ad server and return it to the content platform in order for the user to view it, noting the viewing of said campaign for this user in the database of the AMS.

A third exemplary use would be the case where an AdExchange platform provides the advertising opportunity, that is to say, an advertising opportunity server which are marketplaces where advertising impressions are sold by way of real time bidding (RTB). The AdExchange provides an advertising opportunity, providing the same information which a content webpage would provide to many advertising platforms. Said advertising platforms bid for the impression, in this case the AMS of the invention obtains the information on the user and the profile thereof, the same as in the second case of use previously explained, the bidding is carried out and the AdExchange assigns the opportunity to the highest bidder.

What is claimed is:

1. A method for dynamically establishing content advertisements characterized in that it comprises the following steps:
a) receiving a content request from a user device (110) where said request includes information for identifying said user,
b) obtaining the profile of the user from said identification information of the user,
c) obtaining an advertising plan for said content requested for said user based on the profile of said user and the advertising spaces available in said content where said obtainment of the plan comprises the steps of
(c) (i) selecting a first set of advertisements, the target audience of which has the same characteristics as those of the profile of said user,
(c) (ii) selecting a subset of said first set of advertisements which fulfill the following:
they have not fulfilled the coverage objective or is not within the coverage range which they had fixed and have not fulfilled the objective number of impacts or is not within the range of advertising impacts for said user, or
they have fulfilled the coverage objective or is within the coverage range which they had fixed which have previously impacted on this user and which have not fulfilled the objective number of impacts or is not within the range of advertising impacts for said user
(c) (iii) selecting a subset of the subset obtained in the previous step (ii) which fits into the advertising spaces available for said content;
d) including said advertisements obtained in (c) in said advertising spaces of said content
e) showing said content with said advertisements on the user device (110).

2. The method for dynamically establishing content advertisements according to claim 1, characterized in that it also includes step (f) of updating the coverage objective and the number of impacts associated with said user as a function of selecting advertisements obtained.

3. The method for dynamically establishing content advertisements according to claim 1, characterized in that the information for identifying the user is a unique identifier.

4. The method for dynamically establishing content advertisements according to claim 1, characterized in that the information for identifying the user comprises one or a number of the following: a cookie available on the user device, the IP address of the user device or their access point and the type of device from which it is accessed.

5. The method for dynamically establishing content advertisements according to claim 1, characterized in that said user profile contains one or a number of characteristics such as age, gender, income level, geographic location, types of content which are usually accessed, and interests.

6. The method for dynamically establishing content advertisements according to claim 5, characterized in that said advertisements are characterized at least with the types of characteristics of the user profile.

7. The method for dynamically establishing content advertisements according to claim 6, characterized in that the characterization of said advertisements also includes information on the price of the impacts, the coverage or objective coverage range and the objective number of impacts (OTS) or objective impact range for each individual.

8. The method for dynamically establishing content advertisements according to claim 7, characterized in that the price per impact of said advertisements is also calculated as a function of the target audience, the objective coverage or objective coverage range and the objective number of impacts (OTS) or objective impact range for each individual.

9. The method for dynamically establishing content advertisements according to claim 7, characterized in that the selection of the advertisement subset which fits into the advertising spaces available for said content (iii) incorporates firstly selecting the advertisements whose price per impact will be greater.

10. A system for dynamically establishing content advertisements, characterized in that it comprises:
a) a user device (110) disposed for sending a content request and receiving and showing said content with advertisements, where said request includes information for identifying the user of said device,
b) a content platform (200) disposed for receiving said content request and requesting an advertising plan indicating information of said user and the advertising spaces available for said content from an advertising management platform (300), receiving said plan from said platform (300), including the advertisements of said plan in said content and sending said content with the advertisements to said user device (110),
c) an advertising management platform (300) disposed for receiving an advertising plan request for the advertisement spaces available for said content and for the profile of said user where the obtainment of said plan comprises the steps of:
c.i. selecting a first set of advertisements, the target audience of which has the same characteristics as those of the profile of said user,
c.ii. selecting a subset of said first set of advertisements which fulfill the following:
they have not fulfilled the coverage objective or is not within the coverage range which they had fixed and have not fulfilled the objective number of impacts or is not within the range of advertising impacts for said user, or
they have fulfilled the coverage objective or is within the coverage range which they had fixed which have previously impacted on this user and which have not fulfilled the objective number of impacts or is not within the range of advertising impacts for said user
c.iii. selecting a subset of the subset obtained in the previous step (ii) which fits into the advertising spaces available for said content;
and where once said subset is selected, it is returned to the content platform.

11. The system for dynamically establishing content advertisements according to claim 10, characterized in that said content platform (200) includes a content server (210) with all the content thereof.

12. The system for dynamically establishing content advertisements according to claim 11, characterized in that said content platform (200) has a database with the profiles of the users (220) from where the profile of the user is obtained based on the identification information of the user and where said user profile is included in the request for an advertising plan from said advertising management platform (300).

13. The system for dynamically establishing content advertisements according to claim 12, characterized in that said user profiles stored in said database (200) contain one or a number of characteristics such as age, gender, income level, geographic location, types of content which are usually accessed, and interests.

14. The system for dynamically establishing content advertisements according to claim 10, characterized in that said advertising management platform (300) has a database with the profiles of the users (320) and where the profile of the user is obtained based on the identification information of the user.

15. The system for dynamically establishing content advertisements according to claim 14, characterized in that said user profiles stored in said database (320) contain one or a number of characteristics such as age, gender, income level, geographic location, types of content which are usually accessed, and interests.

16. The system for dynamically establishing content advertisements according to claim 14, characterized in that said advertising management platform (300) for obtaining said user profile also consults an external database (500) with additional information on the users and where said profile is established as a function of the query to said external database (500) and to said database (320) of said platform (300).

17. The system for dynamically establishing content advertisements according to claim 16, characterized in that said external database (500) is a data management platform (DMP).

18. The system for dynamically establishing content advertisements according to claim 10, characterized in that said advertising management platform (300) has a database with the campaigns and advertisements (310).

19. The system for dynamically establishing content advertisements according to claim 18, characterized in that said advertisements stored in said database (310) are characterized at least with the types of characteristics of the user profile.

20. The system for dynamically establishing content advertisements according to claim 19, characterized in that the characterization of said advertisements stored in said database (310) also include information on the price of the impacts, the coverage or objective coverage range and the objective number of impacts (OTS) or objective impact range for each individual.

21. The system for dynamically establishing content advertisements according to claim 20, characterized in that the price per impacts of said advertisements stored in said database (310) is also calculated as a function of the target audience, the objective coverage or objective coverage range and the objective number of impacts (OTS) or objective impact range for each individual.

22. The system for dynamically establishing content advertisements according to claim 10, characterized in that it also includes an advertisement server (400) disposed for providing the advertisements obtained in the plan at the request of said content platform (200).

23. The system for dynamically establishing content advertisements according to claim 10, characterized in that said user device (110) is a television, computer, tablet or smartphone.
